(19) United States
(12) Patent Application Publication
(10) Pub. No.: US 2007/0005370 A1
(43) Pub. Date: Jan. 4, 2007

(54) Voice-activated control system

(76) Inventor: Scott Elshout, McKinney, TX (US)

Correspondence Address: EDWARD SCOTT ELSHOUT, 808 JASPER LANE, MCKINNEY, TX, 75071, US

(21) Appl. No.: 11/172,322

(22) Filed: Jun. 30, 2005

(51) Int. Cl. G10L 21/00

(52) U.S. Cl. 704/275

(57) ABSTRACT

A voice activated control system that uses a microphone to accept verbal commands from the user to control a plurality of electronic and electric devices such as a TV, DVD player, stereo receiver, projector, security system, sprinkler system, computer and the like using their inherent control methods. This is a computer-based system with associated software, which allows input of Infrared (IR) signals, voice commands, and various typed commands or strings and stores these in a database. It then allows for the user to assign one or more commands of any stored type to a virtually unlimited number of unique voice commands for controlling the plurality electronic and electric devices. Said system controls the plurality of electronic and electric devices using their inherent control methods such as IR, Contact Closure, Serial, Ethernet, TCP/IP, USB, IEEE 1394, etc.

### REFERENCES CITED

| | | | |
|---|---|---|---|
| 6,747,566 | Mar. 12, 2001 | Hou | 340/825 |
| 6,606,280 | Feb. 22, 1999 | Knittel | 367/198 |
| 6,721,705 | Feb. 5, 2001 | Kurganov et al. | 704/270 |
| 5,579,221 | Dec. 30, 1994 | Mun | 700/83 |
| 6,643,620 | Mar. 15, 1999 | Contolini | 704/270 |
| 6,868,045 | Sep. 12, 2000 | Schroder | 367/198 |
| 6,594,630 | Nov. 19, 1999 | Zlokarnik et al. | 704/256 |
| 5,345,538 | Jan. 27, 1992 | Narayannan et al. | 704/275 |
| 6,473,661 | Mar. 15, 2000 | Wollner | 700/83 |

### BACKGROUND OF THE INVENTION

1. Field of the Invention

The present invention relates to a voice-activated control system. More specifically, the present invention relates to a computer based voice-activated control system which allows a user to custom program, “match up”, voice commands to device commands enabling the user to verbally turn on and off, operate, and monitor numerous electronic devices such as TV sets, DVD players, stereo systems and alarm systems and numerous electrical devices such as lights, projector screens, and motorized equipment.

2. Description of Related Art

Typically, electronic and electric devices have hand-held remote controls that require the user to manually press buttons to operate the devices. Since each device has its own remote control, the remote controls become hard to keep up with when 2 or more devices are being used. It is very inconvenient to have to use a separate remote to turn on and off and to operate multiple devices. In addition, most of the controls are based on Infrared (IR) signals that are easily interrupted. IR signals are light signals that need to have an uninterrupted path to the electronic device being controlled. Therefore, the signal cannot be sent through walls from room to room or through solid entertainment system doors.

There are currently some voice-activated remote control devices on the market. These devices are not control systems. They are typically hand-held push-button type remotes that are voice enabled. There is a voice-activated remote control unit disclosed in U.S. Pat. No. 6,747,566 entitled Voice-Activated Remote Control Unit For Multiple Electrical Apparatuses issued to Hou on Jun. 8, 2004. This unit allows one or more electrical apparatuses to be controlled through voice command, but it is limited to only IR enabled devices. There are several drawbacks to the voice activated remote devices on the market today. The drawbacks are they are limited in the number of electronic devices they are able to control, they only control IR enabled devices, they are limited in the number of commands that can be stored, and some can only recognize the voice of one user.

Control systems have simplified this task somewhat by allowing the remotes to be combined into one system. However, most control systems are operated via keypads, touch-panels, or additional hand-held remotes. This still requires the user to manually press buttons for the operation of equipment. This also limits the user's ability to freely move about in a room or home since one must be within reach of the keypad or touch-panel to operate the equipment.

A recent attempt at controlling household devices using voice commands is disclosed in U.S. Pat. No. 6,721,705 entitled Robust Voice Browser System and Voice Activated Device Controller issued to Kurganov et al. on Apr. 13, 2004. This system is primarily for acquiring information from sources on a network. In an alternative embodiment, it states it allows users to control and monitor a variety of household devices with voice commands, but they must be connected to a computer network. This can be limiting in what can be controlled, as there are very few network enabled consumer electronics on the market today. This system also does not allow for the control of these devices using their inherent control method. One must also use a voice enabled network device, such as a cell phone or Internet telephone, instead of a simple microphone to communicate with the system.

The major control systems on the market today have one very big drawback. That is they require a professional programmer to program them initially and to make any changes to accommodate additional or changed equipment. This can run up to $125 per hour for programming charges. So this can be inconvenient and expensive for the user.

The present invention allows the user to initially program the system and change the programming at any time without the need to hire a professional programmer.

### SUMMARY OF THE INVENTION

An object of the present invention is to provide a user-friendly computer-based voice-activated control system.

An object of the present invention is to provide a means to connect a plurality of standard to professional-grade wired or wireless microphones for voice input.

An object of the present invention is to provide a system and method to verbally control a plurality of electronic and electric devices using simple to complex voice commands.

An object of the present invention is to provide a system and a method to control a plurality of electronic and electrical devices utilizing their inherent control method.

An object of the present invention is to provide a user friendly programming interface for the user to initially program the system to match the needs of the user and to allow the user to alter the program at any time to accommodate additional or changes in equipment.

An object of the present invention is to provide a means of using a wired or wireless touch-panel as an alternate means of control to be used in addition to or in place of the microphone for controlling said system.

An object of the present invention is to provide a means of using a wired or wireless hand-held computer for utilizing a touch-screen, mouse, or keyboard method as an alternate means of control to be used in addition to or in place of the microphone for controlling said system.

An object of the software of present invention is to capture, store, organize, and delete IR profiles from hand-held remote controls.

An object of the software of the present invention is to permit the user to input, store, organize, and delete the manufacturer names of a plurality of electronic and electrical equipment.

An object of the software of the present invention is to permit the user to input, store, organize, and delete the model names/numbers of a plurality of electronic and electrical equipment.

An object of the software of the present invention is to permit the user to input, store, organize, and delete the equipment type of a plurality of electronic and electrical equipment.

An object of the software of the present invention is to permit the user to input, store, organize, and delete in text form the list of expected voice commands.

An object of the software of the present invention is to permit the assignment of equipment to one of a plurality of outputs for direct control.

An object of the software of the present invention is to provide the user with a user-friendly programming interface to allow the user to program or “match up” voice commands with device commands. The programming can be changed at any time by the user to match an alternate voice command with a device command or a voice command with an alternate device command.

An object of the software of the present invention is to provide the user with a user-friendly programming interface to allow the user to program multiple device commands in sequence with programmable delays between commands for the purpose of activating multiple commands or devices with one verbal command. In this case, the user may want to turn on the TV, the satellite, and the DVD player, and have the TV switch to input 1 with just one verbal command of “system-on”.

An object of the software of the present invention is to permit the user to input and store the communication method of each device being controlled.

An object of the software of the present invention is to permit the user to start and stop the voice recognition manually by using the software interface.

An object of the software of the present invention is to permit the user to start and stop the voice recognition verbally by speaking user defined words or phrases such as “Microphone on” or “Microphone off”.

The present invention includes an IR receiver for capturing IR profiles from hand-held remote controls for storage in the command code database.

The present invention includes a plurality of IR emitter ports for transmitting IR profiles to the intended electronic or electric device.

The present invention includes a plurality of serial ports for one-way or two-way communication with a plurality of electronic devices.

The present invention includes a plurality of I/O ports for monitoring switch and contact closures for feedback from a plurality of electronic or electric devices.

The present invention includes a plurality of USB ports for bi-serial communication with a plurality of USB enabled electronic devices.

The present invention includes a plurality of Ethernet ports for communication over a network, using TCP/IP or any other communications protocol, with a plurality of network enabled electronic devices. This also permits an external control source, such as a network enabled touch panel, keypad, desktop computer, and a hand-held computer to communicate with the control system as an additional means of user input for controlling the plurality of connected electronic or electric devices.

The present invention includes an IEEE 1394 port for communication with a plurality of IEEE 1394 enabled electronic or electric devices.

The present invention includes a plurality of relay outputs for passing or breaking electrical current to a plurality of electronic and electric devices.

### BRIEF DESCRIPTION OF DRAWING

FIG. 1 depicts the system architecture of the invention and the flow of communication within the system and with the devices.

### DESCRIPTION OF THE PREFERRED EMBODIMENT

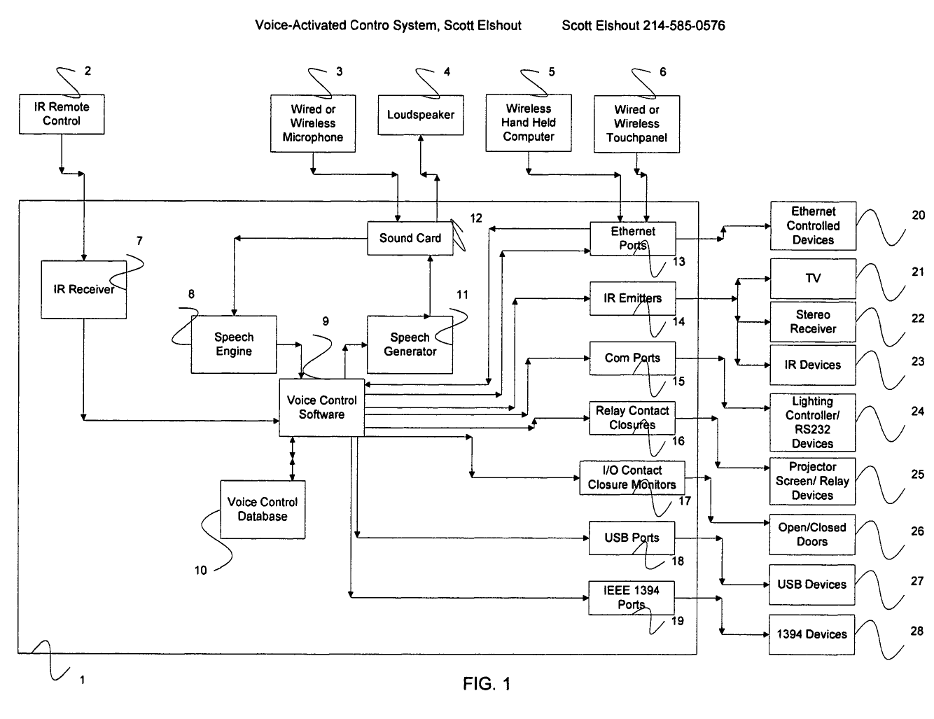

FIG. 1 depicts the system architecture of the control system 1 and the flow of communication within the system and with the plurality of electronic and electric devices 20-28 being controlled.

The voice-activated control system 1 is used to control a plurality of electronic and electric devices 20-28 via the devices' inherent or alternate control method using verbal voice commands from the user.

The voice-activated control system 1 is a computer-based system made up of software components 8-11 and hardware components 7 & 12-19. These components are all enclosed in a single enclosure.

The IR receiver 7 allows the control system to capture IR signals from the hand-held remotes 2 that come with an electronic device such as a TV 21, stereo receiver 22, and any other IR controlled electronic and electric device 23. When capturing the signals, the voice control software 9 requires the user to send each command twice, compares the two commands, and if they are equivalent, saves them in the voice control database 10. If the two commands are not equivalent, the voice control software 9 discards the signals and requires the user to make another attempt.

The microphone 3 is used to capture and send the user's voice commands to the control system's 1 sound card 12. The type of microphone is variable. It may be any wired or wireless microphone on the market that will connect to a computer sound card or computer preamp. Multiple microphones 3 may be used in the system. The function of the microphone 3 is to accept the analog voice signal and convert it to an electrical form. The function of the sound card 12 is to accept the electrical signal from the microphone 3 and convert it to a digital voice signal.

The speech engine software 8 takes the digital voice signal and converts it to an ASCII text form that is sent immediately to the voice control software 9.

The voice control software 9 takes the ASCII text information and searches the voice control database 10 for a user-programmed matching device command. A matching command may consist of an individual command or a batch of commands. If a match is found, the voice control software 9 determines which device(s) the command(s) belongs to, what type of control method the device(s) requires, and to which port(s) 13-19 to send the command(s). The voice-activated control system will be connected via the appropriate wires and wireless method to the electronic and electric devices 20-28. If a matching device command has not been programmed for the users voice command, which has now been translated into ASCII text information, the voice control software 9 sends an instruction to the speech generator software 11 to generate a predetermined word or phrase which is sent to the sound card 12 which is in turn sent to a loudspeaker 4 and comes out as a verbal word or phrase indicating that a matching command has not been programmed for the said verbal command from the user.

The voice control software 9 allows the user to input, store, organize, and delete equipment profiles. More specifically, the voice control software 9 allows the user to input, store, organize, and delete the manufacturer names of a plurality of electronic and electric equipment. The voice control software 9 allows the user to input, store, organize, and delete the model names/numbers of a plurality of electronic and electric equipment. The voice control software 9 allows the user to input, store, organize, and delete the equipment type of a plurality of electronic and electric equipment.

The voice control software 9 allows the user to input, store, organize, and delete in text form the list of expected voice commands. This allows the user to build a custom database of words or phrases that are acceptable as verbal commands from the user.

The voice control software 9 provides a software means in the form of a ‘start recognition’ button and a ‘stop recognition’ button in the user interface for the user to start and stop the voice recognition action of the control system so the system may be inactive without shutting the system down.

The voice control software 9 also provides a verbal means in the form of a user programmable phrase such as ‘microphone on’ and ‘microphone off’ to start and stop the voice recognition action of the control system so the system may be inactive without shutting the system down.

The voice control software 9 provides a means for the user to program specific device commands to activate when the intended verbal command is spoken.

The voice control software 9 displays the currently programmed voice commands and matching device commands so the user can see at a glance what has already been programmed.

The voice control software 9 provides a means for the user to enter a batch of commands so that multiple device commands can be sent to a plurality of electronic and electric devices with just one verbal command.

In addition to the microphone 3, the voice-activated control system may use a wireless hand-held computer 5 and a wired or wireless touch-panel 6 for input to control devices. These would be connected to the voice-activated control system via a network connection.

One method of communication that the voice-activated control system uses to communicate with the plurality of electronic and electric devices is via IR emitters 14.

Another method of communication that the voice-activated control system uses to communicate with the plurality of electronic and electric devices is via Ethernet ports 13.

Another method of communication that the voice-activated control system uses to communicate with the plurality of electronic and electric devices is via Com ports 15.

Another method of communication that the voice-activated control system uses to communicate with the plurality of electronic and electric devices is via relays 16.

Another method of communication that the voice-activated control system uses to communicate with the plurality of electronic and electric devices is via I/O contact closure monitors 17.

Another method of communication that the voice-activated control system uses to communicate with the plurality of electronic and electric devices is via USB ports 18.

Another method of communication that the voice-activated control system uses to communicate with the plurality of electronic and electric devices is via IEEE 1394 ports 19.

What is claimed:

1. A voice-activated computer based control system with computer programs for controlling a plurality of electronic and electric devices comprising:
(a) A computer based controller for controlling and monitoring a plurality of electronic and electric devices;
(b) A wired or wireless microphone for picking up a user's voice commands and transmitting the voice commands to said computer's sound processor;
(c) An internal sound card or external preamp for receiving the analog voice signal from the microphone and converting it into a digital voice signal;
(d) A speech recognition program for the recognition and translation of a plurality of voice commands into usable events to be processed by a custom control program;
(e) A speech synthesis program for verbally responding to the user for feedback;
(f) A custom control program to allow a user to custom match voice commands and device commands;

2. A system as set forth in claim 1 wherein said custom control program further comprises:
(a) A database for storing verbal commands, signal codes, programmed codes, and equipment information;
(b) A user interface to allow the user to custom program the system;
(c) Input means for entering alphanumeric commands to be stored in said database;
(d) Input means for entering alphanumeric voice commands to be stored in said database;
(e) Input means for entering alphanumeric brand names of said plurality of electronic devices to be stored in said database;
(f) Input means for entering alphanumeric model names of said plurality of electronic devices to be stored in said database;
(g) Input means for entering alphanumeric equipment type names of said plurality of electronic devices to be stored in said database;

3. A system as set forth in claim 1, further comprising an Infrared (1R) receiver for receiving IR signals from a plurality of hand-held remotes, which are used to manually control said plurality of electronic and electric devices, for storage in the database.

4. A system as set forth in claim 1, further comprising a plurality of IR emitters for transmitting the stored IR signals to the plurality of electronic and electric devices.

5. A system as set forth in claim 1, further comprising a plurality of serial ports for serial communication to the plurality of serial enabled electronic and electric devices.

6. A system as set forth in claim 1, further comprising a plurality of relays to send and discontinue sending electrical signals to the plurality of electronic and electric devices.

7. A system as set forth in claim 1, further comprising a plurality of Ethernet ports to allow network communication with a plurality of Ethernet enabled electronic and electric devices.

8. A system as set forth in claim 1, further comprising a plurality of Universal Serial Bus (USB) ports to for bi-serial communication to the plurality of USB enabled electronic and electric devices.

9. A system as set forth in claim 1, further comprising a plurality of IEEE 1394 ports for communication to the plurality of IEEE 1394 enabled electronic and electric devices.

10. A system as set forth in claim 1, further comprising a plurality of I/O ports for monitoring switch and contact closures for feedback from a plurality of electronic and electric devices.

11. A system as set forth in claim 1, further comprising a means of using a wired or wireless touch-panel as an alternate means of control to be used in addition to or in place of the microphone for controlling said system.

12. A system as set forth in claim 1, further comprising a means of using a wired or wireless hand-held computer for utilizing a touch-screen, mouse, or keyboard method as an alternate means of control to be used in addition to or in place of the microphone for controlling said system.
